(19) United States
(12) Patent Application Publication
(10) Pub. No.: US 2005/0282531 A1
(43) Pub. Date: Dec. 22, 2005

(54) Methods, mobile devices, data structures and computer program products for configuring mobile devices with network access information included in image data

(76) Inventor: Markus Andreasson, Lund (SE)

Correspondence Address: MYERS BIGEL SIBLEY & SAJOVEC, PO BOX 37428, RALEIGH, NC, 27627, US

(21) Appl. No.: 10/870,747

(22) Filed: Jun. 17, 2004

(51) Int. Cl. H04M 3/00

(52) U.S. Cl. 455/418

(57) ABSTRACT

Mobile devices may be configured for network access by receiving image data at the mobile device including network access information for use by the mobile device in accessing the network. The network access information included in the image data can be processed to provide the network access information in a message format at the mobile device. The mobile device can be configured with the network access information. Related mobile devices, data structures, and computer program products are also disclosed.

### TECHNICAL FIELD OF THE INVENTION

The invention generally relates to the field of electronics and, more particularly, to methods, mobile devices, data structures and computer program products for electronic communications.

### DESCRIPTION OF RELATED ART

It is known to use a cellular mobile device to access the Internet using what is commonly referred to as a Wireless Application Protocol (WAP). For example, access by the mobile device to the Internet using WAP may require the mobile device to communicate with a WAP gateway server using a WAP port number associated therewith.

It is known to configure the mobile device with the WAP gateway address and WAP port number via the user interface of the mobile device. For example, the user of the mobile device may enter the WAP gateway and port number using the keypad of the mobile device when a subscription for Internet service is established. It is also known to configure the mobile device with the WAP gateway and port number using what is commonly referred to as “over-the-air” or OTA programming. In OTA programming, the service provider can transmit an SMS configuration message to the mobile device whereupon the mobile device configures itself with the WAP gateway address and port number included in the SMS configuration message.

Alternatively, the SMS configuration message may be transmitted based on the subscriber's use of the service provider's website through which, for example, Internet service can be initiated. For example, the subscriber may establish Internet service through the service provider's website, which causes the SMS configuration message to be transmitted to the mobile device. It is also known to configure the mobile device for Internet service (with, for example, the WAP gateway address and port number) before delivery to an end user, such as by the service provider or during manufacture of the mobile device prior to sale to the end user.

### SUMMARY

Embodiments according to the invention can provide methods, mobile devices, data structures and computer program products for configuring mobile devices with network access information included in image data. Pursuant to these embodiments, a mobile device can be configured for network access by receiving image data at a mobile device including network access information for use by the mobile device in accessing the network. The network access information included in the image data can be processed to provide network access information in a message format at the mobile device. The mobile device can be configured with the network access information.

In some embodiments according to the invention, the network access information included in the image data can be a Short Message Service formatted mobile device configuration message and/or a Multimedia Message Service formatted mobile device configuration message. In some embodiments according to the invention, the Short Message Service formatted mobile device configuration message or the Multimedia Message Service formatted mobile device configuration message is separate from an over-the-air configuration message.

In some embodiments according to the invention, the network access information can be a Wireless Application Protocol profile for the mobile device and/or a Multimedia Message Service profile for the mobile device. In some embodiments according to the invention, the Wireless Application Protocol (WAP) profile can be a WAP gateway address, a WAP port number, and/or a WAP profile name.

In some embodiments according to the invention, the network access information can include a default home Web page, a timeout information, a default user name, a default password, circuit switched data, connection speed information associated with the circuit switched data, line type associated with the circuit switched data, GPRS access point, username associated with the GPRS access point, password associated with the GPRS access point, and/or parameters associated with access to an e-mail account.

In some embodiments according to the invention, the image data corresponds to at least one one-dimensional barcode configured to encode the network access information and/or at least one two-dimensional barcode configured to encode the network access information. In some embodiments according to the invention, the at least one one-dimensional and/or at least one two-dimensional barcode comprises an SMS and/or MMS formatted mobile device configuration message. In some embodiments according to the invention, receiving image data at the mobile device receiving can include receiving the image data via a camera included in the mobile device.

In some embodiments according to the invention, a mobile device can be configured for network access by providing network access information for access by a mobile device to a network. Image data can be received at the mobile device including the network access information. The network access information included in the image data can be processed, by the mobile, to provide the decoded network access information in a message format at the mobile device. The mobile device can be configured with the network access information.

In some embodiments according to the invention, providing the network access information can include providing the network access information as part of a kit including the mobile device. In some embodiments according to the invention, providing the network access information can include providing the network access information on a receipt associated with a service subscription to the network.

In some embodiments according to the invention, providing the network access information can include providing the network access information in an e-mail message. In some embodiments according to the invention, providing the network access information can include providing the network access information via a computer displayable document.

In some embodiments according to the invention, providing the network access information can include providing the network access information via a mailing associated with a subscription to service from the network. In some embodiments according to the invention, configuring the mobile device for access can further include increasing a size of a view of the network access information on the computer displayable document.

In some embodiments according to the invention, a mobile device can include a transceiver configured to transmit/receive communications to/from a network that provides service to the mobile device. A camera can be configured to provide image data including network access information in a mobile device message format. A processor circuit can be configured to process the image data to provide network access information based on the network access information in the mobile device message format for configuration of the mobile device therewith.

In some embodiments according to the invention, the network access information in the mobile device message format can be a Short Message Service formatted mobile device configuration message and/or a Multimedia Message Service formatted mobile device configuration message. In some embodiments according to the invention, the network access information in the mobile device message format can be a WAP gateway address, a WAP port number, and/or a WAP profile name.

In some embodiments according to the invention, a data structure embodied in an optically compatible media can include network access information in a mobile device message format on the media configured to provide the mobile device with access to a network. In some embodiments according to the invention, the media can be paper, plastic, metal, or a computer displayable document.

In some embodiments according to the invention, a computer program product for configuring a mobile device for network access can include computer readable program code configured to receive image data at a mobile device including network access information for use by the mobile device in accessing the network, computer readable program code configured to process the network access information included in the image data to provide the network access information in a message format at the mobile device, and computer readable program code configured to configure the mobile device with the network access information.

### BRIEF DESCRIPTION OF THE DRAWINGS

FIG. 1 is a schematic diagram that illustrates a wireless communications network including mobile devices according to some embodiments of the invention.

FIG. 2 is a block diagram that illustrates a mobile device according to some embodiments of the invention.

FIG. 3 is a block diagram that illustrates operations of mobile devices according to some embodiments of the invention.

FIG. 4 is a schematic illustration of network access information according to some embodiments of the invention.

FIG. 5 is a schematic drawing that illustrates providing network access information to a mobile device according to some embodiments of the invention.

FIG. 6 is a schematic diagram that illustrates providing network access information to a mobile device according to some embodiments of the invention.

FIG. 7 is a schematic drawing that illustrates providing network access information to a mobile device according to some embodiments of the invention.

FIG. 8 is a flowchart that illustrates operations of mobile devices according to some embodiments of the invention.

### DETAILED DESCRIPTION OF EMBODIMENTS ACCORDING TO THE INVENTION

The invention is described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that although the terms first and second may be used herein to describe various components these components should not be limited by these terms. These terms are only used to distinguish one component from another. Thus, for example, a first component discussed below could be termed a second component without departing from the teachings of the present invention.

The invention is described with reference to flowcharts and block diagrams of mobile devices, communications networks, and operations thereof according to embodiments of the invention. It will be understood that each block of the flowcharts and/or block diagrams, and combinations of blocks, may be implemented by computer program instructions. These computer program instructions may be provided to a processor of a general purpose computer, special purpose computer, other programmable data processing apparatus to produce a machine, such that the instructions, which execute via the processor of the computer or other programmable data processing apparatus, create means for implementing the functions specified in the flowchart and/or schematic block or blocks.

The invention is generally described herein in the context of mobile devices and networks that comply with the Global Standard for Mobile (GSM) communications standard using, for example, Time Division Multiple Access (TDMA) type communications as is well known to those skilled in the art. It will be understood, however, that the invention may be practiced with any mobile device that operates in a communications network. A mobile device may be, for example, a single or dual mode cellular radiotelephone with or without a multi-line display; a Personal Communications System (PCS) terminal that may combine a cellular radiotelephone with data processing, facsimile and data communications capabilities; a Personal Data Assistant (PDA) that can include a mobile device, pager, Internet/intranet access, Web browser, organizer, calendar and/or a global positioning system (GPS) receiver; and a conventional laptop and/or palmtop receiver or other appliance all of which include a radiotelephone transceiver.

It will be understood that mobile devices according to the invention may operate in any type of wireless communications network. In some embodiments according to the invention, for example, the network may provide services broadly labeled as PCS (Personal Communications Services) including advanced digital cellular systems conforming to standards such as IS-136 and IS-95, lower-power systems such as DECT (Digital Enhanced Cordless Telephone), data communications services such as CDPD (Cellular Digital Packet Data), and other systems such as CDMA-2000, that are proposed using a format commonly referred to as Wideband Code Division Multiple Access (WCDMA).

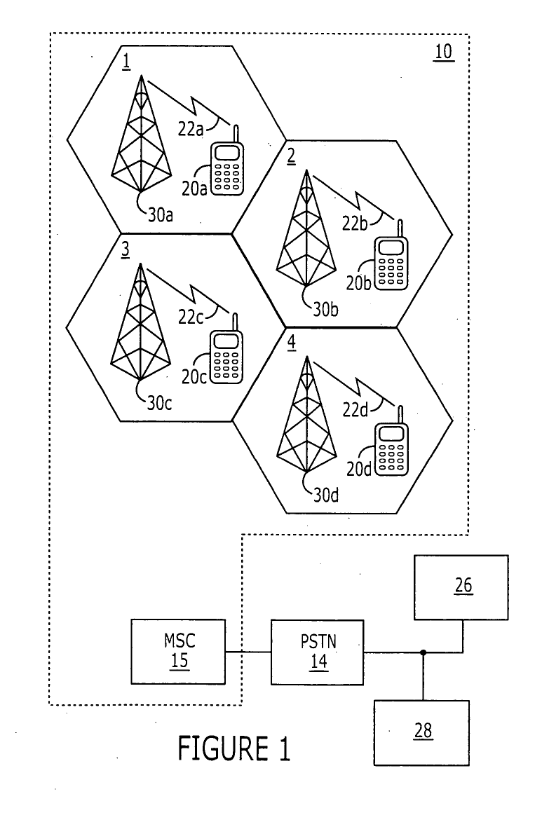

The invention may also be used in celestial communications systems, such as satellite communications systems. The celestial wireless communication system may be employed to perform similar functions to those performed by the communications network of FIG. 1. In particular, the celestial wireless communication system typically includes one or more satellites that serve as relays or transponders between one or more earth stations and (satellite) mobile devices. The satellites typically communicate with the satellite mobile devices and earth stations via duplex communication links. Each earth station may, in turn, be connected to a Public Switched Telephone Network (PSTN) in a terrestrial communications networks, thereby allowing communications between the satellite mobile device, and other devices serviced by the network.

The celestial wireless communication system may utilize a single antenna beam covering the entire geographic region served by the system or the celestial wireless communication system may be designed such that it produces multiple overlapping or non-overlapping beams that serve different sub-regions of the entire geographic region served by the celestial wireless communications system. The satellites and the respective sub-regions may serve a function similar to that of the base stations and the associated cells of the communications network.

FIG. 1 is a diagram that illustrates a wireless communications network (or network) 10 that supports GSM type communications in which mobile devices 20a-d according to the invention can be used. Networks 10 are commonly employed to provide voice and data communications to subscribers using, for example, the standards discussed above. According to FIG. 1, a plurality of mobile devices 20a-d can communicate with each other and other terminals, such as terminals 26, 28, via the network 10 and a PSTN 14.

The wireless communications network 10 is organized as cells 1-4 that collectively can provide service to a geographic region. In particular, each of the cells can provide service to associated sub-regions included in the geographic region covered by the network 10. More or fewer cells can be included in the network 10, and the coverage area for the cells 1-4 may overlap. Each of the cells 1-4 may include an associated base station 30a-d. The base stations 30a-d can provide wireless communications between each other and the mobile devices 20a-d in the associated geographic region to allow for communications therebetween.

Each of the base stations 30a-d can transmit/receive data to/from the mobile devices 20a-d over an associated control channel 22a-d. For example, the base station 30a in cell 1 can communicate with the mobile device 20a over the control channel 22a. The control channel 22a can be used, for example, to page the mobile device 20a in response to calls directed thereto or to transmit traffic channel assignments to the mobile device 20a over which a call associated therewith is to be conducted. The control channels 22a-d can be identified using control channel numbers or identifiers. For example, the mobile device 20a can store a channel number that identifies control channel 22a as the control channel on which it is currently camping.

The mobile devices 20a-d are configured to register with the network 10 when, for example, the mobile devices are turned on. In particular, the mobile devices 20a-d use information, stored on a SIM card in the respective mobile device, to register with the network 10. Once the mobile devices 20a-d are registered with the network 10, the mobile devices 20a-d can receive service from the wireless communications network 10, such as placing and receiving calls via the wireless communications network 10 as the mobile devices 20a-d move within the geographic region serviced by the network 10.

The mobile devices 20a-d may also be capable of receiving messages from the network 10 over the respective control channel 22a-d. In some embodiments according to the invention, the mobile devices receive Short Message Service (SMS) or Enhanced Message Service (EMS) formatted messages, Multimedia Message Service (MMS), and/or Smartmessaging™ formatted messages. As is known to those skilled in the art, SMS and EMS messages can be transmitted on digital networks, such as GSM networks, allowing relatively small text messages (for example, 160 characters in size) to be sent and received via the network operator's message center to the mobile device 20, or from the Internet, using a so-called SMS (or EMS) “gateway” website. If the mobile device 20 is powered off or out of range of the network, the SMS messages (or commands) can be stored by the network 10, and may be delivered later when the mobile device 20 is available.

MMS is a messaging system for asynchronous mobile-to-mobile messaging, which is based on the SMS standard, but which enables communication of messages containing “rich media” content, i.e., content of types that tend to be more data-intensive than text, such as such as graphics, digital photographs, video, animation, sound files, and/or audio. MMS is standardized by the WAP Forum and the Third-Generation Partnership Project (3GPP) and is described in: “WAP MMS, Architecture Overview,” WAP-205, WAP Forum (Approved Version Apr. 25, 2001); “WAP MMS, Client Transactions Specification,” WAP-206, WAP Forum (Approved Version Jan. 15, 2002); “WAP MMS, Encapsulation Specification,” WAP-209, WAP Forum (Approved Version Jan. 5, 2002); “Requirements”, 3GPP specification 22.140; and “Architecture and Functionality,” 3GPP specification 23.140.

WAP has been promulgated to enable application programs to be written to operate on a wide array of wireless communications networks by providing a standard for the presentation and delivery of wireless information and telephony services. As a result, various mobile devices, such as mobile devices, pagers, two-way radios, smartphones and communicators can utilize WAP to enable delivery of relevant information and services to mobile devices.

The SMS, EMS, and MMS messages can be configuration messages that include commands that cause the mobile device to configure itself with, for example, network access information, which is sometimes referred to as “over-the-air” (or OTA) programming. Once configured, a WAP client (such as a Web browser) in the mobile device may access the Internet through a WAP gateway that is associated with the network access information.

In operation, in order to receive information from sources on the Internet, a user typically inputs a request to navigate to a Uniform Resource Locator (URL) associated with the desired data information to the WAP client (device). For example, in order to display a website associated with information relating to gas stations, a URL identifying the website is input to the WAP client (on the mobile device). The WAP client utilizes the URL to build a request in a binary format, and transmits the request to the WAP gateway, which then decodes the binary request and builds a hypertext transfer protocol (HTTP) request, adding additional headers not included in the original request if needed. The HTTP request is then forwarded by the WAP gateway to a server. Upon receiving the request, the server composes and transmits an HTTP response, which may include information requested by the user, which is forwarded to the mobile device via the WAP gateway.

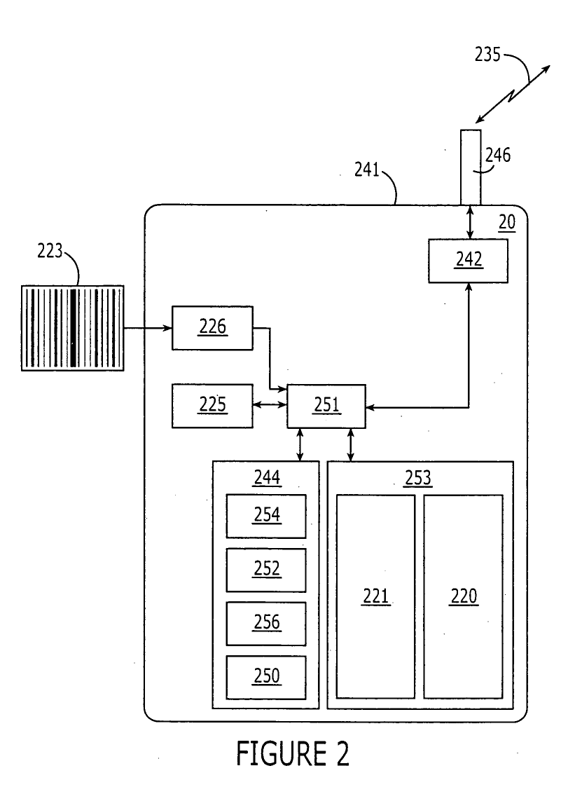

FIG. 2 is a block diagram that illustrates a mobile device 20 according to some embodiments of the invention. As illustrated in FIG. 2, the mobile device 20 includes a transceiver circuit 242 that is operative to transmit and receive radio frequency communication signals to the network 10 via an antenna system 246. The antenna system 246 may include an antenna feed structure and one or more antennas.

As is well known to those of skill in the art, a transmitter portion of the transceiver 242 converts the information which is to be transmitted by the mobile device 20 into electromagnetic signals suitable for radio communications. A receiver portion of the transceiver 242 demodulates electromagnetic signals which are received by the mobile device 20 from the network 10 to provide the information contained in the signals in a format which is understandable to the user.

A user interface 244 of the mobile device 20 may include a variety of components, such as a display 254, a keypad 252, a speaker 256, and a microphone 250, operations of which are known to those of skill in the art. It will be understood that the functions of keypad 252 and the display 254 can be provided by a touch screen through which the user can view information, such as computer displayable documents, provide input thereto, and otherwise control the mobile device 20.

A processor circuit 251 provides for overall operation of the mobile device 20 including coordination of communications via the transceiver circuit 242, the user interface 244, and other components and systems included in the mobile device 20. For example, the processor circuit 251 can provide communications signals to the transceiver 242 when the user speaks into the microphone 250 and receives communications signals from the transceiver 242 for the reproduction of audio through the speaker 256. The processor circuit 251 can generate characters for display on the display 254. For example, the processor circuit 251 can generate numbers for display when the user enters a telephone number on the keypad 252. The characters can also be generated by a character generator circuit which is not shown.

The processor circuit 251 may be implemented using a variety of hardware and software. For example, operations of the processor circuit 251 may be implemented using special-purpose hardware, such as an Application Specific Integrated Circuit (ASIC) and programmable logic devices such as gate arrays, and/or software or firmware running on a computing device such as a microprocessor, microcontroller or digital signal processor (DSP).

The mobile device 20 includes a SIM card 225. The SIM card 225 can be installed (or removed) from the mobile device 20 by inserting (or removing) the SIM card 225 into/from a SIM card holder. The SIM card 225 stores information, such as an International Mobile Subscriber Identity (IMSI) that identifies the subscriber to the network 10 and a secret key for authentication. In some embodiments according to the invention, the IMSI includes a 3-digit Mobile Country Code (MCC) which identifies the country and a 2-digit Mobile Network Code (MNC) which identifies the network within that country. It will be understood that the SIM card 225 can store other types of data, such as a Wireless Application Protocol (WAP) profile that provides at least a portion of the network access information for interfacing the mobile device to the network for services relating to wireless Internet as well as data storage services.

A memory 253 can store computer program instructions that, when executed by the processor circuit 251, carry out the operations described herein and shown in the figures. The memory 253 can be non-volatile memory, such as EEPROM (or flash memory), that retains the stored data while power is removed from the memory 253 to enable the storage of information, such as the WAP profile described above, to provide access to the network for the mobile device 20.

The memory 253 also includes an optical recognition module 221 that includes computer program instructions configured to recognize information included in image data. The optical recognition module 221 may also be configured to translate the recognized data to a format that can be used to configure the mobile device 20.

The memory 253 can also include a message processor 220 that operates to, for example, configure the mobile device 20 in response to messages received via the processor circuit 251. For example, the configuration messages processed by the message processor 220 can be SMS, EMS or MMS formatted configuration messages described above.

The mobile device 20 also includes a camera 226 that is configured to generate image data corresponding to images sampled by the camera 226. For example, the camera 226 can be used to capture an image of a barcode 223 to generate image data corresponding thereto. In other words, the image data generated by the camera 226 includes a portion of the image sampled by the camera 226 that includes the barcode 223. In some embodiments according to the invention, the image sampled by the cameras 226 includes network access information that can be used to configure the mobile device to provide access to the network. For example, the network access information can be embodied in the barcode 223 that is sampled by the camera 226 to produce image data that includes the network access information to configure the mobile device 20. In some embodiments according to the invention, the barcode 223 can be a one-dimensional or two-dimensional barcode 223. In still further embodiments according to the invention, the network access information can be included in multiple one-dimensional or two-dimensional barcodes 223 which can be sequentially scanned by the camera 226 and concatenated by the processor circuit 251 to provide the network access information (and other information included in the barcodes 223).

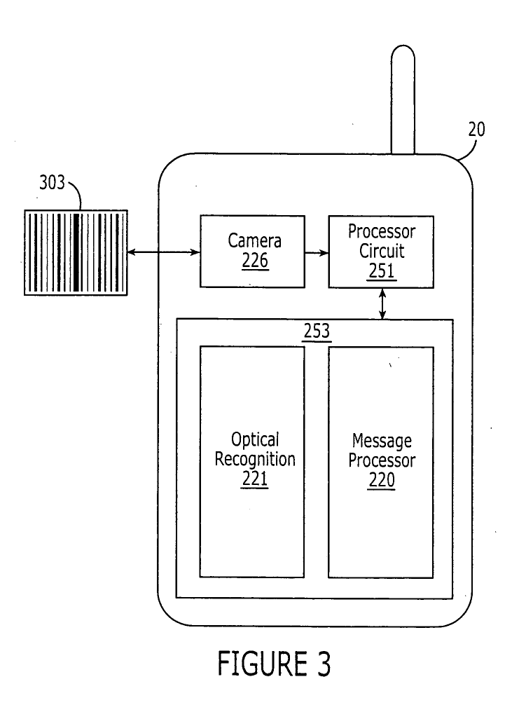

FIG. 3 is a schematic drawing that illustrates operations of mobile devices according to some embodiments of the invention. In particular, network access information can be embodied in a data structure 303 on a medium such as paper, plastic, metal, and/or the like. It will be understood that the medium on which the data structure 330 appears has properties that allow the camera 226 to accurately sample the image of the data structure 303. As described above, the network access information included in the data structure 303 can be included in a barcode. It will be further understood that the network access information included in the data structure 303 can take the form of basic information used for network access, such as a WAP gateway address and/or a WAP port number and can be formatted as a configuration message for processing by the mobile device 20. For example, the data structure 303 can include the network access information in a complete SMS configuration message so that the processor circuit 251 may process the configuration message in analogous fashion to that used to process OTA configuration messages. Other types of message formats, such as a proprietary message format may be used.

In operation, the camera 226 included in the mobile device 20 samples an image including the barcode representing the data structure 303 to produce image data which is provided to the processor circuit 251. The processor circuit 251 can utilize the optical recognition module 221 described above in reference to FIG. 2 to convert the barcode included in the image data received from the camera 226 into the network access information included therein. Furthermore, if the barcode included in the image data is formatted as a mobile device configuration message, the processor circuit 251 can initiate configuration of the mobile device 20 using the network access information recognized within the barcode. Furthermore, if the barcode and the image data represents an SMS or MMS formatted configuration message, the processor circuit 251 may utilize the message processor 220 to configure the mobile device 20. Accordingly, the processor circuit 251 may process configuration messages included in the image data in the same way as messages received from the network according to the OTA programming approach discussed herein. Moreover, the processor circuit 251 may utilize the same message processor 220 to process messages originating from either OTA or from the camera 226.

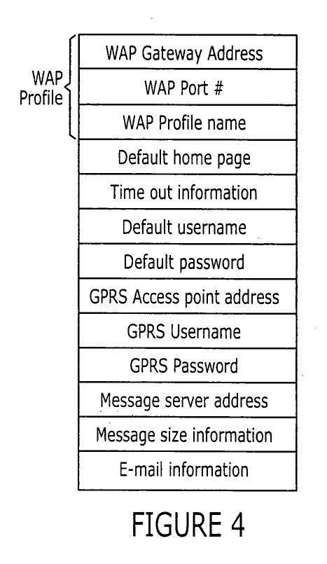

FIG. 4 is a block diagram that illustrates network access information according to some embodiments of the invention. In particular, network access information can include a WAP gateway address that identifies an IP address of a wireless application protocol gateway to be used by the WAP client in the mobile device 20 when accessing the Internet. Furthermore, the network access information can also include a WAP port number that can be used in conjunction with the WAP gateway address when accessing the Internet. The WAP gateway address and the WAP port number can be associated with a WAP name (such as “Vodaphone”) to define a WAP profile that includes the gateway address and port number so that these values may be referenced by WAP clients or users when requesting access to the Internet or distinguishing between different service providers. It will be understood that the WAP profile can include other parameters that are known to be used as part of the wireless applications protocol.

The network access information can also include a default home web page to which the WAP client is directed upon initiating a connection to the Internet via the WAP gateway. Time out information can also be included in the network access information to define the time that the WAP client will wait to receive a response to a request. The network access information can also include a default user name and password which may be used for initial access to Internet services whereupon the user may redefine the user name and password.

A general packet radio service (GPRS) access point (as well as a respective user name and password for the GPRS access point) can be defined for continuous connection to, for example, Internet data services. The network access information can also include an IP address of a message service server (such as an SMS, EMS, and/or MMS service website) that can be used, for example, to store and forward formatted messages to the mobile device and associated message size information. In some embodiments according to the invention, the network access information also includes e-mail address information, such as IP addresses associated with incoming and outgoing mail servers.

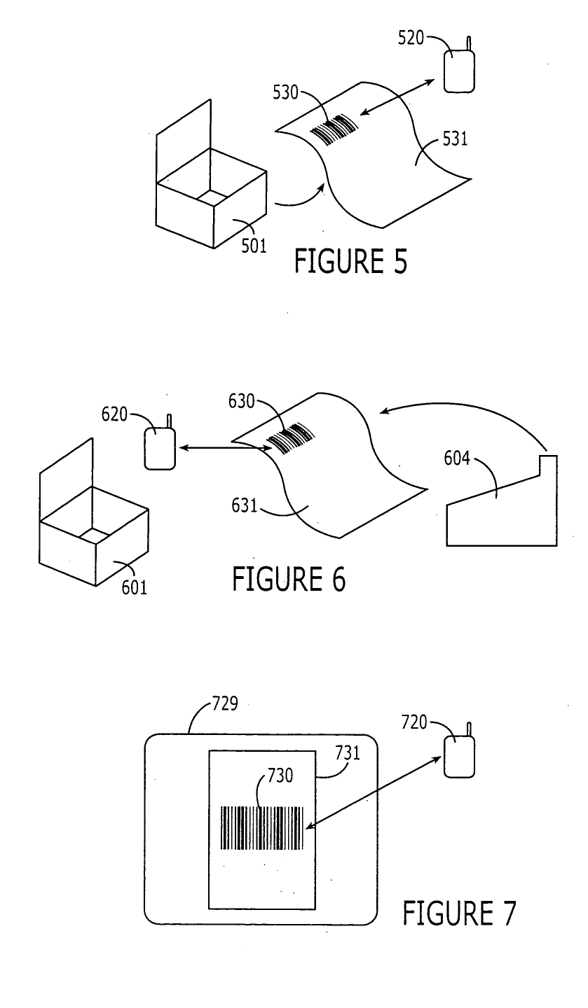

FIG. 5 is a schematic diagram illustrating methods of configuring mobile devices for network access according to some embodiments of the invention. In some embodiments according to the invention, a subscriber obtains a mobile device 520 and network access information and configures the mobile device 520 for access to the network using a camera included in the mobile device 520 to capture an image of the network access information included in a data structure 530 on a medium 531.

In some embodiments according to the invention, the data structure 530 including the network access information appears on paper, plastic and/or metal or the like so that the camera may adequately sample the network access information thereon. In some embodiments according to the invention, the network access information is included in the data structure 530 is embodied in a barcode format. In some embodiments according to the invention, the network access information is formatted as a portion of a mobile device configuration message, such as an SMS, EMS, MMS or other type of configuration message.

As shown in FIG. 5, the mobile device 520 can be included in a kit 501 along with the network access information included in the data structure 530 which may be printed on a medium 531. In some embodiments according to the invention, the network access information is provided as part of the kit 501 without the mobile device 520. In some embodiments according to the invention, the kit 501 can be in a closed package so as to protect the network access information from unauthorized access.

Upon opening the kit 501, the user or salesperson may use the camera included in the mobile device 520 to capture an image including the network access information included in the data structure. As discussed above, the data structure can be embodied in one or more one-dimensional or two-dimensional barcodes. When the mobile device 520 receives the image data and includes the network access information, the processor circuit processes the network access information included in the image data to provide the network access information in a message format to the mobile device. The network access information in the message format can be used to configure the mobile device 20 to provide network access thereto.

FIG. 6 is a schematic diagram illustrating methods of configuring mobile devices 620 for network access according to some embodiments of the invention. As shown in FIG. 6, a data structure 630 including the network access information can appear on, for example, a receipt 631, printed for example by a terminal 604, made available at a point of sale or subscription associated with the mobile device 620. For example, the receipt 631 including the network access information may be provided separately from when a mobile device 620 is initially purchased (in other words, after service has been initially provided). Accordingly, the receipt 631 including the network access information may be associated with the subscription that provides network access to the mobile device 620, rather than a sale thereof.

In operation, the mobile device 620 may capture an image including the data structure 630 with the network access information to provide image data to the processor circuit therein. As described above, the network access information included in the data structure 630 may be a formatted configuration message (such as an SMS, EMS or MMS configuration message). The processor circuit processes the network access information included in the image data to provide network access information in the message format for the mobile device 620. The processor circuit can use the network access information to configure the mobile device 620 to provide access to the network.

FIG. 7 is a schematic diagram illustrating methods of configuring mobile devices 720 for network access according to some embodiments of the invention. As shown in FIG. 7, a data structure 730 including the network access information can be provided on a display 729 as part of a computer displayable document 731 (such as a web page on a website) associated with the service provider. In particular, the subscriber may access the webpage via the Internet and enter some information associated with a subscription for the mobile device 720.

As is known to those skilled in this art, a Web page is conventionally formatted via a standard page description language such as HyperText Markup Language (HTML), which typically contains text and can reference graphics, sound, animation, and video data. HTML provides for basic document formatting and allows a Web content provider to specify anchors or hypertext links (typically manifested as highlighted text) to other servers. When a user selects (i.e., activates) a particular hypertext link, a browser running on the user's client device reads and interprets an address, called a Uniform Resource Locator (URL) associated with the hypertext link, connects the browser with a Web server at that address, and makes a request (e.g., an HTTP request) for the file identified in the hypertext link. The Web server then sends the requested file to the client which interprets and renders the Web page for display. It will be understood that data structures 730 according to some embodiments of the invention, can be practiced with any computer displayable document including, for example, a web page of a website with barcoded network access information appearing thereon.

A mobile device 720 according to some embodiments of the invention can capture an image including network access information included in the data structure 730 on the computer displayable document 731. In some embodiments according to the invention, the data structure is a barcode that encodes the network access information. Furthermore, in some embodiments according to the invention, a view of the barcode on the webpage may be scaled to increase the view which may improve the image data on which the processor circuit operates to recognize the barcoded network access information.

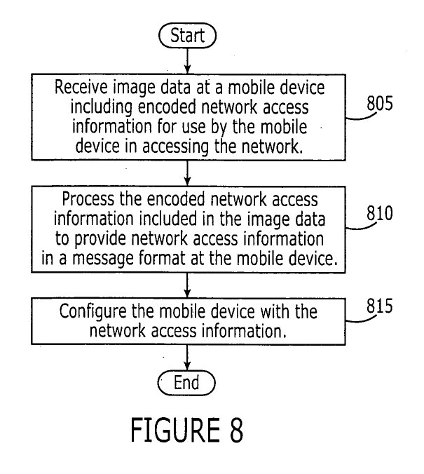

FIG. 8 is a flowchart that illustrates methods of configuring mobile devices according to some embodiments of the invention. According to FIG. 8, the mobile device captures an image including network access information at the mobile device (block 805). As discussed above, the network access information can be included in a barcode as part of a data structure that appears on a medium such as paper, plastic, metal, or a display so that an accurate image thereof can be sampled. In some embodiments according to the invention, the data structure including the network access information is displayed on a computer displayable document such as a webpage.

The mobile device processes the network access information included in the image data to provide network access information in a message format at the mobile device (block 810). In some embodiments according to the invention, the message format is a short message an SMS formatted mobile device configuration message and/or a multi-medium service formatted mobile device configuration message. As discussed above, formatting the network access-information as part of a message can allow the processor circuit in the mobile device to process messages included in image data in the same way as messages received via an over the air programming channel. Furthermore, in some embodiments according to the invention, the network access information can include a wireless application protocol profile and/or a multi-medium message service profile for the mobile device. The mobile device can be configured using the network access information using the message format included in the image data provided via the camera (block 815).

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

1. A method of configuring a mobile device for network access comprising:
receiving image data at a mobile device including network access information for use by the mobile device in accessing the network;
processing the network access information included in the image data to provide network access information in a message format at the mobile device; and
configuring the mobile device with the network access information.

2. A method according to claim 1 wherein the network access information included in the image data comprises Short Message Service formatted mobile device configuration message and/or a Multimedia Message Service formatted mobile device configuration message.

3. A method according to claim 2 wherein the Short Message Service formatted mobile device configuration message or the Multimedia Message Service formatted mobile device configuration message is separate from an over-the-air configuration message.

4. A method according to claim 2 wherein the network access information comprises a Wireless Application Protocol profile for the mobile device and/or a Multimedia Message Service profile for the mobile device.

5. A method according to claim 4 wherein the Wireless Application Protocol (WAP) profile comprises a WAP gateway address, a WAP port number, and/or a WAP profile name.

6. A method according to claim 2 wherein the network access information comprises a default home Web page, a timeout information, a default user name, a default password, circuit switched data, connection speed information associated with the circuit switched data, line type associated with the circuit switched data, GPRS access point, username associated with the GPRS access point, password associated with the GPRS access point, and/or parameters associated with access to an e-mail account.

7. A method according to claim 1 wherein the image data corresponds to at least one one-dimensional barcode configured to encode the network access information and/or at least one two-dimensional barcode configured to encode the network access information.

8. A method according to claim 7 wherein the at least one one-dimensional and/or at least one two-dimensional barcode comprises an SMS, MMS, and/or Smartmessaging™ formatted mobile device configuration message.

9. A method according to claim 1 wherein receiving image data at the mobile device receiving comprises receiving the image data via a camera included in the mobile device.

10. A method according to claim 1 embodied in a computer program product.

11. A method of configuring a mobile device for network access comprising:
providing network access information for access by a mobile device to a network;
receiving image data at the mobile device including the network access information;
processing the network access information included in the image data, by the mobile, to provide the decoded network access information in a message format at the mobile device; and
configuring the mobile device with the network access information.

12. A method according to claim 111 wherein providing the network access information comprises providing the network access information as part of a kit including the mobile device.

13. A method according to claim 11 wherein providing the network access information comprises providing the network access information on a receipt associated with a service subscription to the network.

14. A method according to claim 11 wherein providing the network access information comprises providing the network access information in an e-mail message.

15. A method according to claim 11 wherein providing the network access information comprises providing the network access information via a computer displayable document.

16. A method according to claim 11 wherein providing the network access information comprises providing the network access information via a mailing associated with a subscription to service from the network.

17. A method according to claim 15 further comprising:
increasing a size of a view of the network access information on the computer displayable document.

18. A mobile device comprising:
a transceiver configured to transmit/receive communications to/from a network that provides service to the mobile device;
a camera configured to provide image data including network access information in a mobile device message format; and
a processor circuit configured to process the image data to provide network access information based on the network access information in the mobile device message format for configuration of the mobile device therewith.

19. A mobile device according to claim 18 wherein the network access information in the mobile device message format comprises a Short Message Service formatted mobile device configuration message and/or a Multimedia Message Service formatted mobile device configuration message.

20. A mobile device according to claim 18 wherein the network access information in the mobile device message format comprises a WAP gateway address, a WAP port number, and/or a WAP profile name.

21. A mobile device according to claim 18 wherein the network access information comprises a default home Web page, a timeout information, a default user name, a default password, circuit switched data, connection speed information associated with the circuit switched data, line type associated with the circuit switched data, GPRS access point, username associated with the GPRS access point, password associated with the GPRS access point, and/or parameters associated with access to an e-mail account.

22. A mobile device according to claim 18 wherein the image data corresponds to at least one one-dimensional barcode configured to encode the network access information and/or at least one two-dimensional barcode configured to encode the network access information.

23. A mobile device according to claim 18 wherein the at least one one-dimensional and/or at least one two-dimensional barcode comprises an SMS and/or MMS formatted mobile device configuration message.

24. A data structure embodied in an optically compatible media comprising:
network access information in a mobile device message format on the media configured to provide the mobile device with access to a network.

25. A data structure according to claim 24 wherein the media comprises paper, plastic, metal, or a computer displayable document.

26. A data structure according to claim 24 wherein the network access information in the mobile device message format comprises a Short Message Service formatted mobile device configuration message and/or a Multimedia Message Service formatted mobile device configuration message.

27. A data structure according to claim 24 wherein the network access information in the mobile device message format comprises a WAP gateway address, a WAP port number, and/or a WAP profile name.

28. A computer program product for configuring a mobile device for network access, comprising:
a computer readable medium having computer readable program code embodied therein, the computer readable program code comprising:
computer readable program code configured to receive image data at a mobile device including network access information for use by the mobile device in accessing the network;
computer readable program code configured to process the network access information included in the image data to provide the network access information in a message format at the mobile device; and
computer readable program code configured to configure the mobile device with the network access information.
